(19) United States
(12) Patent Application Publication
(10) Pub. No.: US 2008/0278805 A1
(43) Pub. Date: Nov. 13, 2008

(54) Sweet Spot Unit For a Multi-User Display Device With an Expanded Viewing Zone

(75) Inventor: Armin Schwerdtner, Dresden (DE)

Correspondence Address: FOX ROTHSCHILD LLP, P O BOX 592, 112 NASSAU STREET, PRINCETON, NJ, 08542-0592, US

(73) Assignee: SEEREAL TECHNOLOGIES GMBH, Dresden (DE)

(21) Appl. No.: 11/817,883

(22) PCT Filed: Mar. 8, 2006
(86) PCT No.: PCT/DE06/00413

§ 371 Date: Sep. 6, 2007

(30) Foreign Application Priority Data
Mar. 9, 2005 (DE) 10 2005 012 348.1

(51) Int. Cl. G02B 27/22

(52) U.S. Cl. 359/463

(57) ABSTRACT

The invention relates to a sweet spot unit for multiple user display with an enlarged observation area, preferably for an electronic display for reproducing stereoscopic and/or monoscopic representation which are automatically oriented towards the eyes of different observers by means of a position finder and a tracking and image control system. A said sweet spot unit contains deviation means (5), between the imaging means (3) and the image matrix, provided with deviation elements (511, 512, . . . 51n) which have a width (W_{L}) and are periodically arranged in groups (L, N, R) in a matrix, vertically in accordance with the vertical screening (H_{V}) of the illumination matrix (1). Each group deviates the bundle of rays (91, 92, 93, . . . ) respectively at another pre-determined angle, in order to reproduce the same in one of a plurality of horizontally arranged sweet spots areas. Said sweet spot unit also contains an illumination matrix (1) comprising illumination elements that can be vertically activated according to the groups (L1, N1, R1); optical means for vertical enlargement (7), which increase the height of the bundle of rays according to the vertical reproduction of the illumination elements; and an optically scattering medium (8) as the last element in the direction of the light upstream of the image matrix.

### FIELD OF THE INVENTION

The present invention relates to a sweet spot unit for use in a multi-user display device with an expanded viewing zone, preferably for use in an electronic display for providing stereoscopic and/or monoscopic views, which are directed to the eyes of multiple viewers with the help of a position detector and a tracking and image controller.

### TECHNICAL BACKGROUND AND KNOWN SOLUTIONS

In this document, the term “multi-user display” designates a device which can be used by multiple viewers for simultaneously providing individual view sequences directed to their respective eyes. Generally, with such display devices viewers can only perceive views without cross-talking, if their eyes are located at predetermined positions. These positions are also known in the literature as sweet spots. According to the solution described herein, homogeneously distributed light, which is modulated with image information by an image modulator matrix, is focussed in locally confined sweet spots in a large viewing zone. These sweet spots are tracked by a tracking and image controller according to the movement of the respective viewer's eyes and independently of the image information contained therein such that individual sweet spots do not interfere with each other.

The sweet spot unit described herein is a direction-controlled backlight for the illumination of a large-area transmissive image matrix, such as an LCD panel. It allows the image modulator matrix to be viewed through the sweet spots from various eye positions. The position detector determines the position or eye positions of the viewers and provides position information to a sweet spot controller. The sweet spots can have an extension which allows accommodating one or both eyes of one or multiple viewers.

The image modulator matrix modulates the light for the sweet spots with the information of one or multiple image signals, which may either present direction information of provided stereoscopic views for the respective eye of the viewers, or different stereoscopic and/or monoscopic views. To show stereoscopic views, image sequences of a first video signal are directed to the right eyes of the viewers and image sequences of a second video signal are directed to their left eyes.

According to the solution described herein, combinations of several operational modes are possible. For example, a multi-user display device in a vehicle can provide the driver with monoscopic graphic information to support driving and navigation, while the passenger views a stereoscopic entertainment programme. In this exemplary application, the sweet spot unit directs a first, large sweet spot modulated with monoscopic information by the image modulator matrix to both eyes of the driver. Two smaller sweet spots are directed towards the eyes of the passenger, each sweet spot containing direction information of a stereoscopic view for the respective eye.

Generally, a multi-user display device can provide either temporally or spatially interleaved stereoscopic views. Although the corresponding two types of multi-user display devices are of substantially different design, the interleaving method is irrelevant in the context of the present invention. Temporally interleaved images are alternately presented to the two eyes. This is why the sweet spot unit generates the sweet spots for the two viewer's eyes alternately and in synchronism with the corresponding stereoscopic images. This means that a first group of sweet spots directed to the left eyes is always followed by a second group of sweet spots directed to the right eyes. The light of each sweet spot always permeates the entire image modulator matrix, and the modulator image matrix only modulates the light with the video signal of a single image at each moment.

In devices with a spatially interleaved providing of left and right images, the sweet spot unit provides all sweet spots simultaneously. Light of each sweet spot only permeates certain sections of the image modulator matrix, and the image matrix simultaneously modulates the light with the video signals of all the images which shall be presented to the individual viewer groups at a certain moment. For example, the right half of the image matrix can be assigned to a first viewer, and the remaining half to another viewer. Both halves can encode monoscopic or stereoscopic image contents. Further, each half can be subdivided into any number of sections.

For greater clarity, the present invention will preferably be described in conjunction with the method of temporal interleaving of single images for each viewer's eye.

WO 03/019952 A1 discloses a display device with a tracking system for stereoscopic and monoscopic viewing for multiple viewers. A controlled optical directivity system on the image matrix with two lens arrays, including a shutter, separately focuses each pixel of the image on to the viewer's eyes. A lens array comprises a separate lens element for each pixel of the image modulator matrix, said lens element focusing the light modulated by that pixel on to the shutter. The shutter has a multitude of minute segment openings per pixel, so as to be able to open one segment per lens element for each viewer according to their eye position. The segments are projected on to the viewers' eyes through a corresponding second lens element of the second lens array disposed behind the shutter. If a viewer moves, a position detector transmits the viewer's new position, so as to only open the shutter segments which correspond with that position, in order to ensure the pixels remain focused on the eyes. The different images are provided to the corresponding eyes in the time-multiplexed mode. If multiple viewers watch stereoscopic views, multiple segments are activated, corresponding to the number of viewers.

Such a multi-user display is rather difficult to be realised in practice, because the shutter must have an extremely high resolution. In particular, a very large number of segments per line and the assignment of lens elements and shutter openings to the pixels of the image modulator matrix require extreme precision when manufacturing the components and when aligning them during assembly. Further, the display panel is required to exhibit great resistance to ambient influences, such as temperature fluctuation or vibration. Another disadvantage is that lens arrays and shutters must always precisely harmonise with the image modulator matrix as regards their geometry, resolution, and manufacturing tolerances.

EP 0773462 describes a stereoscopic single-user display with a lenticular array for stereoscopic representation which aims to prevent the occurrence of pseudoscopic views. That device can be used, for example, in automatic teller machines and video phones. It contains a flat display panel, a lenticular array and diffracting means which focus main beam lobes for a left image in a left image viewing point and main beam lobes for a right image in a right image viewing point. This is achieved by a layer of prism rows. In a preferred embodiment, the diffracting means are formed by a layer of lenticulars combined with prisms.

Prior patent application DE 103 39 076 filed by the applicant however, not published before the day of this application, also describes a multi-user display device. It contains a controllable sweet spot unit, which is formed by a directed backlight disposed behind a transmissive LCD image matrix, and is used to view the images on the image modulator matrix from eye positions within these sweet spots. A tracking and image controller connected with a position detector tracks the sweet spots according to the eye positions. A projection matrix with a multitude of lenticules arranged vertically in a lenticular array projects switchable point illumination elements of an illumination matrix on to a viewer's eyes.

FIG. 1 shows a single projection system of the sweet spot unit with a detail of the illumination matrix 1, where the illumination elements in columns 12 and 14 are activated, and a lenticule 31 of the lenticular array in the form of a single cylindrical lens, said lenticule projecting the active illumination elements in two collimated bundles of rays 911, . . . , 91n and 921, . . . , 92n. Each other lens element of the projection matrix forms a similar projection system with other active illumination elements of the illumination matrix 1.

The position detector determines the eye positions of viewers in front of the display device, and the tracking and image controller activates corresponding illumination elements of the illumination matrix for these viewers in order to render visible the current image of the sequence of images from the detected eye positions. For this, illumination elements at different positions, here columns 12 and 14, are activated according to the eye positions in relation to the projecting lenticule such that the bundles of rays 911 . . . 91n and 921 . . . 92n overlap in the eye positions (not shown) in front of the display device, each forming a sweet spot having a rhombic shape with increasing distance from the display panel. The activated illumination elements usually differ from lenticule to lenticule strongly enough for the directed bundles of rays to intersect in the sweet spots. The illumination matrix and the image modulator matrix are synchronised so that all sweet spots activated at a time only show one image of a stereoscopic sequence of images. The images for the other eye of the viewers are modulated by the image matrix in synchronism after switching over to another sweet spot or another sweet spot group. The image for the other eyes must not be illuminated, i.e. it must be invisible as a so-called dark spot during that period. The bundles of rays propagate in a way that every active illumination element is visible at the eye positions, where it has a diameter of at least several millimetres, so as to cover at least the eye pupil. The synchronisation of image sequences and sweet spots is not only applied to a total image and a total frame of the illumination matrix, but can be applied more finely to line ranges or even individual lines, up to the synchronisation of pixel groups of the image matrix and illumination matrix per lens element.

The sweet spot unit described in patent application DE 103 39 076 has the advantage that the width W_{L} of the lenticules can be chosen freely when the device is fabricated. The lenticular array can be dimensioned such that each lenticule covers horizontally a multitude of illumination elements, irrespective of the pixel size of the LCD image matrix. This allows sweet spots to be realised for a large number of viewers even though the illumination matrix has a relatively large grid. In a grid of illumination elements determined by the type of illumination matrix used, the number of possible eye positions can preferably be defined by the width of the lens elements of the lenticular array. The width W_{L} of the lens element must be large to get a large number of possible eye positions.

As each lens element generally extends over the entire height of the image modulator matrix in the vertical direction, each lens element covers several hundreds of illumination elements of the illumination matrix.

The eye positions of the viewers differ mainly in their horizontal dimension. This is why it is switched between illumination elements in different horizontal positions, i.e. between columns of the illumination matrix, in order to minimise the computing power required to process information for tracking and image control. As shown in FIG. 1, different columns of illumination elements of the illumination matrix 1 are activated for different sweet spots. While in the vertical direction, each illumination element must be used to generate a stripe sweet spot, in the horizontal direction usually only one or very few illumination elements are required per lens element and sweet spot.

### DESCRIPTION OF THE TECHNOLOGICAL PROBLEM

A sweet spot unit in a multi-user display device, which for example provides two users with stereoscopic views, must supply four sweet spots to serve the four eye positions. To permit a convenient use of the device it cannot be assumed that all viewers are situated in a narrow viewing zone around the central axis of the display when they watch the images. Known solutions often contain simple projection elements, which are typically composed of a high-precision lenticular array. Such simple optical systems cause aberrations, known from lens theory, which restrict the useful viewing angles. The viewing angle is limited mainly by optical aberrations of the lenticular array. Such aberrations always occur, but in particular if the bundles of rays emanate from the lenticules at a large angle. This concern in particular sweet spots for viewers who watch the display a far distance situated from the central axis. Viewing angles of more than 25° are difficult to achieve. Moreover, with the sweet spot unit described above, particularly wide lenticules must be used in order to get a large number of possible eye positions.

Because of the above-mentioned optical errors for large viewing angles, sweet spots which exhibit the required quality cannot be generated using a simple lenticular array. As the angle to the central axis increases, the aberrations cause adverse effects such as cross-talking of sweet spots and loss of homogeneity in the lenticular array, thus deteriorating the perception of image information. If acceptable quality standards are to be met, known solutions can hardly be applied for simultaneous viewing by multiple users, they are in particular unsuitable when it comes to stereoscopic viewing.

### SUMMARY OF THE INVENTION

The object of the present invention is to provide a sweet spot unit for use in a multi-user display device, preferably for use in an electronic display device, for the optional providing of stereoscopic and monoscopic views, which has a viewing zone that can be tracked with the help of a position detector and a tracking and image controller, said viewing zone being substantially wider than that of known solutions. The display shall enable the viewers to move freely and independently in a wide viewing zone, while it only employs simple projection means. It shall be possible to generate sweet spots which exhibit great brightness and contrast, low cross-talk and great luminance homogeneity in the entire viewing zone.

Further, it shall be possible to use commercially available illumination means, such as a backlight with a shutter, or active illumination matrices with a grid independent of that of the projection matrix and that of the image modulator matrix.

The present invention is based on a multi-user display with a sweet spot unit which is controlled by a tracking and image controller, and which directs bundles of rays through a transmissive image modulator matrix and focuses them on to sweet spots of a predetermined extension at several eye positions of viewers. The sweet spot unit is a controllable, directed backlight for the image modulator matrix, which modulates the bundles of rays, which are assigned to several viewer's eyes and which overlap so as to form sweet spots, with separate image sequences in a time- or space-multiplex method. Each sweet spot thereby provides a separate view for the corresponding eye. The sweet spot unit contains an illumination matrix controlled by the tracking and image controller, said matrix being composed of a multitude of discretely controllable illumination elements with a vertical height of H_{V}, and projection means with lens elements having a width of W_{L} for focusing the illumination elements in bundles of rays to the sweet spots. The tracking and image controller activates for each lens element illumination elements corresponding in spatial position, thereby giving each bundle of rays a direction, whereby the extension of the viewing zone is much larger than with known solutions.

The invention is based on the idea of composing several sweet spot regions which are next to each other in the horizontal direction to form the viewing zone. For this, the projection means additionally contain matrix-structured deflection means with deflection elements arranged vertically in periodically reoccurring groups. Further, a vertical diffusing medium is disposed near the image matrix.

Each group of deflection elements assigns the sweet spots horizontally to an individual sweet spot region. By vertically selecting active illumination elements in the columns of the illumination matrix it will be defined into which sweet spot region a horizontal pattern of active illumination elements is projected. Because this way not all illumination elements of a column of the illumination matrix contribute to all sweet spots, optical means for vertical expansion are used which enlarge the bundles of rays vertically depending on the number of available groups.

According to this invention, the sweet spot unit contains:
deflection means having deflection elements arranged in a matrix and being located between the projection means and image modulator matrix: more precisely arranged in periodically reoccurring groups so as to correspond with the height of the illumination elements, whereby each group of deflection elements deflects the bundles of rays at a different, predetermined angle such as to project them into one of several sweet spot regions, which are situated next to each other horizontally;
an illumination matrix, where the illumination elements in each column can be activated according to those groups, such as to project the bundles of rays into a desired sweet spot region;
optical means for vertical expansion, which enlarge the vertical extension of the bundles of rays when the illumination elements are projected; and
A diffusing medium as the last element in front of the image matrix, seen in the direction of light propagation.

Thanks to the division into several sweet spot regions and accordingly staggered deflection angles of the groups of deflection elements, the viewing zone can be expanded by multiples at a given number of pixels per lens element in the horizontal direction. For each pattern of horizontal illumination element settings, the corresponding sweet spot region can thus be used by vertically selecting the active illumination elements in a column based on the corresponding deflection elements in the groups. It is thereby not necessary to only activate illumination elements which are assigned to one group of deflection elements.

A great advantage of this invention lies in the fact that illumination elements which are assigned to deflection elements of different groups can be activated simultaneously. This makes it possible, for example, to activate illumination elements for a first group of deflection elements such as to direct two separate sweet spots with stereoscopic image information in a first sweet spot region on to the two eyes of a first viewer. At the same time, other illumination elements for a second group of deflection elements can be activated such as to direct two separate sweet spots with stereoscopic image information in another sweet spot region each on to the eyes of another viewer, or to direct a single, large sweet spot with monoscopic image content on to both eyes of the other viewer. The case may occur that the same horizontal positions for the illumination elements but in two different lines are activated according to the different sweet spot regions.

As only parts of the image matrix would be illuminated because of the above-described formation of groups, which would result in a patchy image, a diffusing medium is used to close these illumination gaps.

In a preferred embodiment of this invention the deflection means are prism-shaped deflection elements with a width of the prisms corresponding with the width of the lens elements and a height corresponding with the height of the illumination elements, whereby the deflection elements are aligned horizontally with the grid of the lens elements and vertically with the grid of the illumination elements.

### BRIEF DESCRIPTION OF THE FIGURES

The present invention will be described below with the help of accompanying drawings.

FIG. 1 shows a detail of a sweet spot unit as suggested by the applicant in prior patent application DE 103 39 076.

FIG. 2 shows a detail of a first embodiment of the sweet spot unit according to this invention with a first possible order of projection means, deflection means, optical means for vertical expansion, and diffusing means.

FIG. 3 shows the functional principle of this invention, but without the functions of the optical means for vertical expansion and the diffusing means.

FIG. 4a shows a detail of the deflection means in the form of a deflection matrix according to a first embodiment, where the prism-shaped deflection elements have like deflection angles in each line and the deflection angles change line by line.

FIG. 4b shows a detail of the deflection matrix according to a second embodiment with prism-shaped deflection elements of all deflection angles in one line.

FIG. 5 shows a detail of the first embodiment with the beam path of active illumination elements.

FIG. 6 shows a detail of a second embodiment with beam path and inverse order of deflection means and optical means for vertical expansion.

FIG. 7 shows a detail of a further embodiment with beam path, where the optical means for vertical expansion are disposed in front of the projection matrix.

FIG. 8 shows a combination of projection matrix and deflection matrix to form a single optical matrix.

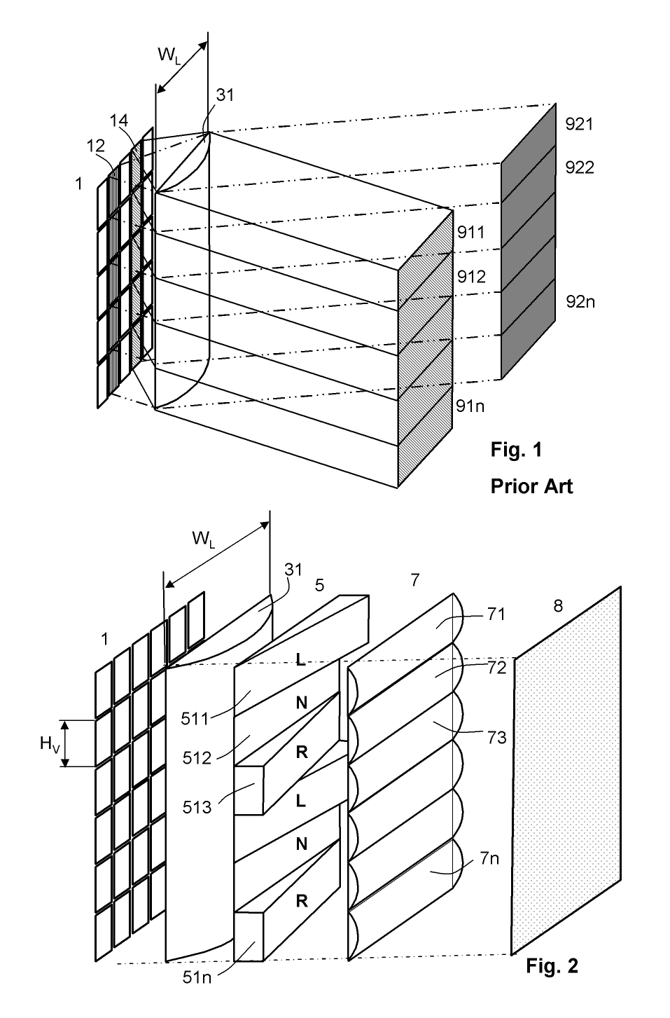

### DETAILED DESCRIPTION OF PREFERRED EMBODIMENTS OF THE INVENTION

The present invention will be described below with the help of embodiments and accompanying drawings.

FIG. 2 shows a first embodiment of the sweet spot unit according to this invention. It contains an illumination matrix 1 and a first possible order of projection means with a lenticular array, of which only one lenticule 31 is shown in the Figure, deflection means 5 which according to this invention has the form of a deflection matrix consisting of deflection elements 511 . . . 51n, optical means for vertical expansion 7, and the diffusing medium 8. All elements provide up a sweet spot unit, which is disposed in light direction in front of an image modulator matrix. It is shown in detail only for clarity. An illumination matrix 1 with 4800×3600 illumination elements may for example be used for an image matrix with 1600×1200 pixels. The illumination matrix 1 may as well have other formats. The illumination elements may be active or passive, i.e. the illumination matrix 1 may be a shutter with a backlight, an LED matrix, or an OLED matrix. In order to avoid aberrations, the height of the deflection elements 511 . . . 51n should correspond with the height H_{V} of the illumination elements, and their width with the width W_{L} of the lens elements (in FIG. 2 represented by the vertical lenticule 31). The width of the deflection elements, here the prisms, may alternatively be an integer multiple of the width W_{L} of the lens elements.

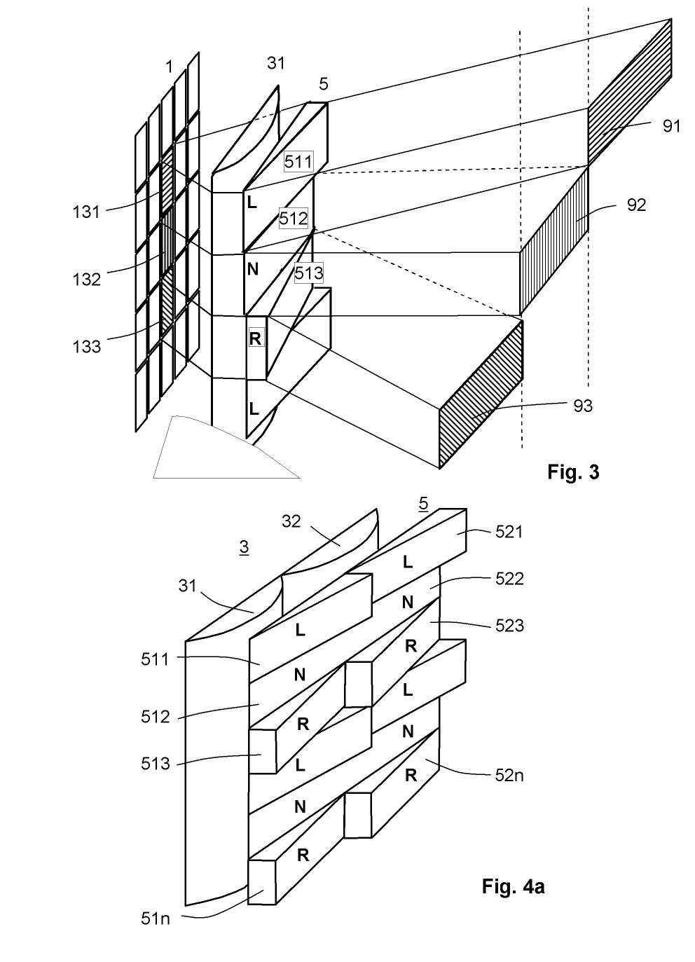

FIG. 3 illustrates the function of the sweet-spot unit according to the present invention. Lens element 31 collimates the light of the active illumination element 131 to form a bundle of rays 91. The prism-shaped deflection element 511 of the deflection means 5 in the form of a deflection matrix 5 belongs to a group which deflects the bundles of rays, here bundle 91, seen in the direction of light propagation, because of the inclination of the light-exit prism face. Elements of that group of the deflection matrix 5 are thus marked with the character “L”. Bundles of rays which originate behind such a deflection element are projected into a sweet spot region on the right hand side, seen from the viewer's position.

Element 512, which is situated one line down in the same column does not have an inclined light-exit face. That element 512 directs a bundle of rays 92 without deflection straight on into a central sweet spot region. Elements of that group of the deflection matrix 5 are thus marked with the character “N”.

The bundle of rays originating from the active illumination element 133, which is situated one line down in the same column of the illumination matrix 1, goes through deflection element 513, which belongs to a group which deflects the bundles of rays, here bundle 93, to the right hand side. This is why the bundles of rays appear in a left sweet spot region, seen from the viewer's position. Those deflection elements are thus marked with the character “R” in the Figure.

Summarising, FIG. 3 shows how illumination elements in one column with like vertical position are projected into different sweet spot regions only by selecting a certain line of the illumination matrix 1. The described sweet spot unit contains an exemplary deflection matrix with three groups (L, N, and R) of deflection elements, as shown in FIG. 2. Said matrix projects the bundles of rays into three different sweet spot regions. However, it is possible to vary this design. In particular, with displays where no sweet spots are required in the central viewing zone, such as multi-user displays in vehicles, the number of deflection angles may preferably be increased. Driver and passenger can thus, for example, view individual images on a display in large viewing angles and at seating positions distant from each other.

FIG. 3 shows the sweet spot unit without the optical means for vertical expansion 7. It can be seen that this means is a major element as regards the homogeneous illumination of the image matrix. The depiction of the image matrix is omitted. Together with the diffusing medium 8, the optical means for vertical expansion 7 compensate regions not directly illuminated, which would naturally occur because of the inactive illumination elements in each column of the illumination matrix. The optical means for vertical expansion 7 enlarge the vertical extension of the bundles of rays 91, 92, 93, which then homogeneously illuminate the image matrix together with the diffusing medium 8. The major idea for the expansion of the viewing zone is to address the angle positions in a confined viewing zone, to which further viewing zones can be added by using deflection elements 5. It is therefore necessary for the deflection elements 5 to be disposed behind the lateral projection means 3 in the direction of light propagation. Otherwise, because of the large angles of light emanating from the projection means 3, substantial aberrations would occur, which would hardly permit laterally confined sweet spots to be generated.

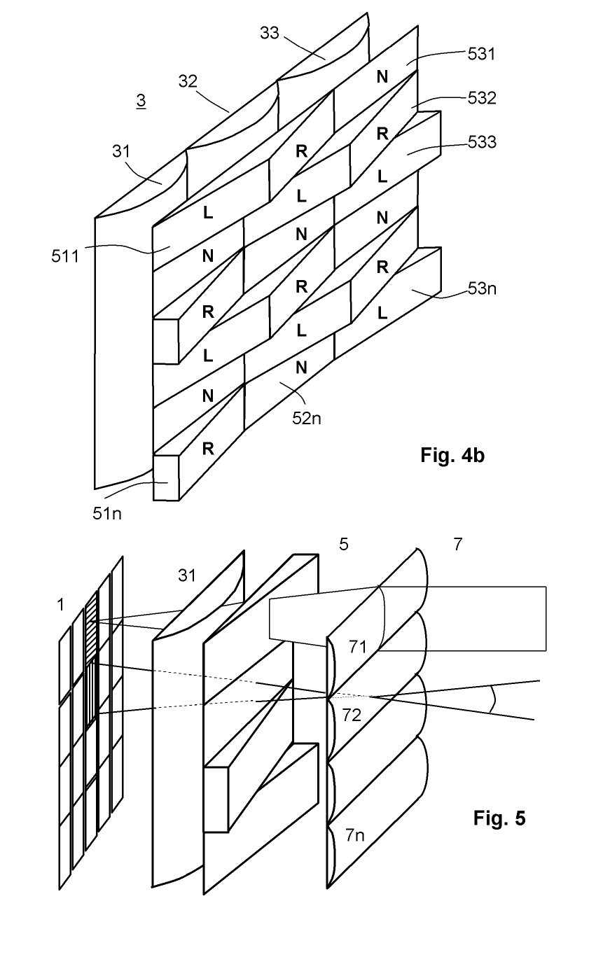

FIG. 4a shows a first embodiment of the deflection matrix 5, where the prism-shaped deflection elements 511, 521 . . . 51n, 52n in one line have like deflection angles, and where the deflection angles change line by line. The shown deflection matrix 5 provides advantages in controlling the illumination matrix, because the illumination elements only need to be discretely controllable horizontally. Entire lines of the illumination matrix can thereby also be controlled in groups of lines.

FIG. 4b shows a second embodiment of the deflection matrix 5, where the prism-shaped deflection elements 511, 521, 531 . . . 51n, 52n, 53n are arranged such that the ends of the deflection elements are attached to each other in a continuous fashion, i.e. without jumps between horizontally adjacent elements. This design provides great advantages in manufacturing the deflection matrix, in particular when making the master form, for moulding or the application by roll embossing on a substrate or carrier foil.

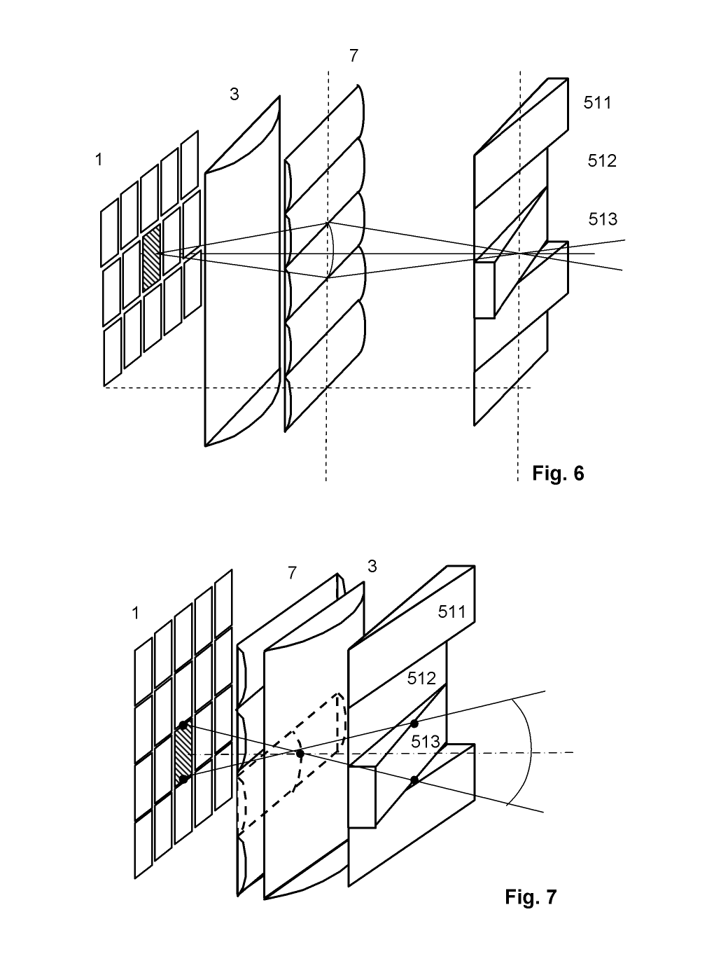

FIG. 5 shows the deflection matrix 5 according to the first embodiment of this invention with the beam path of active illumination elements. The light is focused in the horizontal direction into sweet spot regions. However, as illustrated in FIG. 3, there are vertical gaps, which are closed in the image matrix plane by optical means for vertical expansion 7, here in the form of horizontal lenticules 71 . . . 7n.

In order to be able to illuminate the image matrix homogeneously, a vertically diffusing medium must be disposed between the expansion means and the image matrix. This is shown in FIG. 2, but without the image matrix. FIG. 2 shows the height H_{V} of the illumination elements and the width W_{L} of the lens elements, here the lenticule 31.

An explicit representation of the vertical diffusing medium is omitted below. However, such a medium is always required in each of the following arrangements.

As already explained, the deflection matrix 5 must be disposed behind the projection matrix 3, seen in the direction of light propagation. However, the deflection matrix 5 and the optical means for vertical expansion 7 can be swapped.

FIG. 6 shows an arrangement where the deflection matrix 5 is disposed behind the optical means for vertical expansion 7.

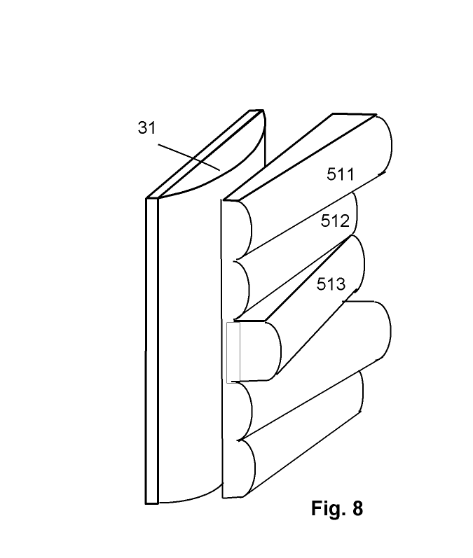

FIG. 7 shows another preferred arrangement, where the vertical angle at which the light emanates from the last element can be large.

FIG. 8 shows a particularly preferred embodiment of deflection elements 511, 512 . . . of the deflection matrix 5. These elements are formed such that they additionally realise the function of the horizontal lenticules of the projection means. In this way, the two separate optical elements shown in FIG. 6 are replaced by a single combined element. This greatly reduces costs and time needed for alignment of the two elements in the fabrication process.

1. Sweet spot unit for use in a multi-user display device having a viewing zone and containing:
an illumination matrix with a multitude of illumination elements being arranged in a vertical structure (HV), whereby a tracking and image controller can activate these elements discretely and
projection means having lens elements which have a width (WL), said projection means projects bundles of rays via a transmissive image modulator matrix into a viewing space and to sweet spots at various positions of viewer's eyes,
where the image modulator matrix modulates the bundles of rays for each sweet spot with an image signal of a separate stereoscopic views, characterised in that
deflection means (5) having deflection elements (511 . . . 53n) arranged in a matrix are situated between the projection means (3) and image modulator matrix, whereby the deflection elements are arranged in periodically reoccurring groups (L, N and R) so as to correspond with the vertical structure (HV) of the illumination matrix (1), where each group (L, N and R) of deflection elements (511 . . . 53n) deflects the bundles of rays (91, 92, 93) at a different, predetermined angle such as to project them into one of several sweet spot regions, which are situated next to each other horizontally;
the illumination elements (131, 132, 133) can be activated vertically corresponding to these groups (L, N, R) such as to project the bundles of rays (91, 92, 93) into the selected sweet spot region by selecting certain active illumination elements (131, 132, 133) in each column of the illumination matrix (1);
there are optical means for vertical expansion (7), which enlarge the vertical extension of the bundles of rays (91, 92, 93); and
a vertical diffusing medium (8) is disposed as the last element in front of the image matrix, seen in the direction of light propagation.

2. Sweet spot unit according to claim 1, where the deflection element width matches with the lens width (W_{L}).

3. Sweet spot unit according to claim 1, where the deflection means has a matrix of prism-shaped optical deflection elements, wherein the width of the prisms corresponds with the width (W_{L}) of the lens elements and a height corresponding with the vertical structure (HV) of the illumination elements, whereby the deflection elements are aligned horizontally with the grid of the lens elements and vertically with the grid of the illumination elements.

4. Sweet spot unit according to claim 3, where the prism-shaped deflection elements (511, 521 . . . 51n, 52n) in one line of the deflection matrix have like deflection angles, and where the deflection angles change line by line so that a certain sequence reoccurs periodically, or where permutations of these sequences are possible.

5. Sweet spot unit according to claim 3, where the prism-shaped deflection elements (511, 521, 531 . . . 51n, 52n, 53n) in the lines of the deflection matrix are arranged such that the ends of the individual deflection elements are attached to each other without jumps between horizontally adjacent elements.

6. Sweet spot unit according to claim 1, where the deflection means (5) are disposed behind the projection means (3), seen in the direction of light propagation, while the optical means for vertical expansion (7) can be disposed in front of or behind the projection means (3) or in front of or behind the deflection means (5).

7. Sweet spot unit according to claim 1, where the lens elements of the projection means are elements (31, 32, and 33) of a lenticular array.

8. Sweet spot unit according to claim 1, where the optical means for vertical expansion (7) is a lenticular array of cylindrical lenses with lens elements (71 . . . 7n) arranged horizontally, and with a focal plane which lies near the plane formed by the illumination matrix.

9. Sweet spot unit according to claim 6, where the deflection elements of the deflection matrix are formed such that they also realise the function of the optical means for vertical expansion (7).
